(19) United States
(12) Patent Application Publication
(10) Pub. No.: US 2026/0141911 A1
(43) Pub. Date: May 21, 2026

(54) ELECTRONIC DEVICE, METHOD, AND COMPUTER-READABLE STORAGE MEDIUM FOR MODIFYING VOICE SIGNAL

(71) Applicant: Samsung Electronics Co., Ltd., Suwon-si (KR)

(72) Inventors: Youngsoo PARK, Suwon-si (KR); Gangyoul KIM, Suwon-si (KR); Yangsu KIM, Suwon-si (KR); Namwoog LEE, Suwon-si (KR); Keunwon JANG, Suwon-si (KR); Hyunmin CHOI, Suwon-si (KR)

(21) Appl. No.: 19/443,793

(22) Filed: Jan. 8, 2026

Related U.S. Application Data
(63) Continuation of application No. PCT/KR2024/008419, filed on Jun. 18, 2024.

(30) Foreign Application Priority Data
Aug. 17, 2023 (KR) 10-2023-0107824
Oct. 6, 2023 (KR) 10-2023-0133466

(51) Int. Cl. G10L 21/0208

(52) U.S. Cl. CPC G10L 21/0208

(57) ABSTRACT

An electronic device is provided. The electronic includes a communication circuit, a microphone, a memory including one or more storage media, storing instructions, and at least one processor communicatively coupled to the communication circuitry, the microphone, and the memory, wherein the instructions, when executed by the at least one processor individually or collectively, cause the electronic device to, in a first state related to a call connection with an external electronic device, based on at least one of a first voice signal obtained through the microphone, a second voice signal received through the communication circuitry, and the first state, determine whether to tune the first voice signal, in a second state for tuning the first voice signal, obtain first voice data for transmission to the external electronic device, by applying at least one filter to the first voice signal, and in a third state distinct from the second state, at least temporarily cease an application of the at least one filter to the first voice signal.

### CROSS-REFERENCE TO RELATED APPLICATION(S)

This application is a continuation application, claiming priority under 35 U.S.C. § 365(c), of an International application No. PCT/KR 2024/008419, filed on Jun. 18, 2024, which is based on and claims the benefit of a Korean patent application number 10-2023-0107824, filed on Aug. 17, 2023, in the Ministry of Intellectual Property, and of a Korean patent application number 10-2023-0133466, filed on Oct. 6, 2023, in the Ministry of Intellectual Property, the disclosure of each of which is incorporated by reference herein in its entirety.

### BACKGROUND

### 1. Field

The disclosure relates to an electronic device, a method, and a computer-readable storage medium for changing a voice signal.

### 2. Description of Related Art

Recently, the proliferation of various types of electronic devices, such as a smartphone, a tablet personal computer (PC), a wireless earphone, and a smartwatch, is expanding. These electronic devices may provide a call service. An electronic device may tune a voice signal while using a call service. The electronic device may use at least one filter to tune the voice signal.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a computer-readable storage medium for changing a voice signal.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, a microphone, memory, including one or more storage media, storing instructions, and at least one processor communicatively coupled to the communication circuitry, the microphone, and the memory, wherein the instructions, when executed by the at least one processor individually or collectively, cause the electronic device to, in a first state related to a call connection with an external electronic device, based on at least one of a first voice signal obtained through the microphone, a second voice signal received through the communication circuitry, and the first state, determine whether to tune the first voice signal, in a second state for tuning the first voice signal, obtain first voice data for transmission to the external electronic device, by applying at least one filter to the first voice signal, and in a third state distinct from the second state, at least temporarily cease the application of the at least one filter to the first voice signal.

In accordance with another aspect of the disclosure, a method of operating an electronic device is provided. The method includes, in a first state related to a call connection with an external electronic device, based on at least one of a first voice signal obtained through a microphone, a second voice signal received through communication circuitry, and the first state, determining whether to tune the first voice signal, in a second state for tuning the first voice signal, obtaining first voice data for transmission to the external electronic device, by applying at least one filter to the first voice signal, and in a third state distinct from the second state, at least temporarily ceasing the application of the at least one filter to the first voice signal.

In accordance with another aspect of the disclosure, one or more non-transitory computer readable storage media storing one or more computer programs including computer-executable instructions that, when executed by at least one processor of an electronic device individually or collectively cause the electronic device to perform operations are provided. The operations include, in a first state related to a call connection with an external electronic device, based on at least one of a first voice signal obtained through a microphone, a second voice signal received through communication circuitry, and the first state, determining whether to tune the first voice signal, in a second state for tuning the first voice signal, obtaining first voice data for transmission to the external electronic device, by applying at least one filter to the first voice signal, and in a third state distinct from the second state, at least temporarily ceasing the application of the at least one filter to the first voice signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates an example of a block diagram of an electronic device, according to an embodiment of the disclosure;

FIG. 3 illustrates an example of an operation in which an electronic device determines whether to perform tuning of a voice signal, according to an embodiment of the disclosure;

FIG. 4 illustrates an example of a flowchart indicating an operation of an electronic device, according to an embodiment of the disclosure;

FIG. 5 illustrates an example of a flowchart indicating an operation in which an electronic device determines tuning of a voice signal based on identifying a state related to a call connection, according to an embodiment of the disclosure;

FIG. 6 illustrates an example of a flowchart indicating an operation in which an electronic device determines tuning of a voice signal based on identifying a ring back tone, according to an embodiment of the disclosure;

FIG. 7 illustrates an example of a flowchart indicating an operation in which an electronic device determines tuning of a voice signal based on identifying noise according to an embodiment of the disclosure;

FIG. 8 illustrates an example of a flowchart indicating an operation in which an electronic device determines tuning of a voice signal based on identifying a preset input, according to an embodiment of the disclosure;

FIG. 9 illustrates an example of a flowchart indicating an operation in which an electronic device determines tuning of a voice signal based on establishing a call connection with a plurality of external electronic devices, according to an embodiment of the disclosure; and

FIG. 10 illustrates an example of a flowchart indicating an operation in which an electronic device determines tuning of a voice signal received through communication circuitry based on a wearing state of an earbud, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

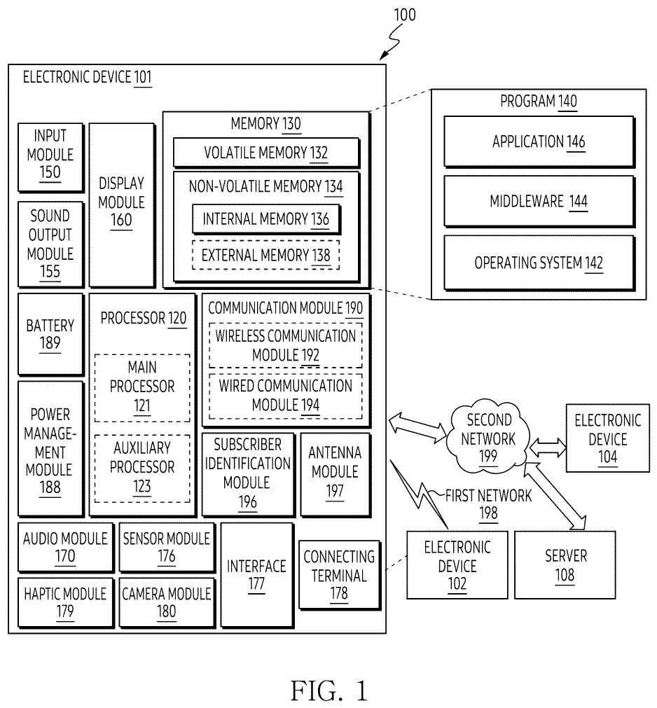

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to another embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. In an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to another embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may be configured to store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to another embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. In an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to another embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. The camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to another embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to another embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. In an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to some embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may, for example, provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). In an example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to another embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

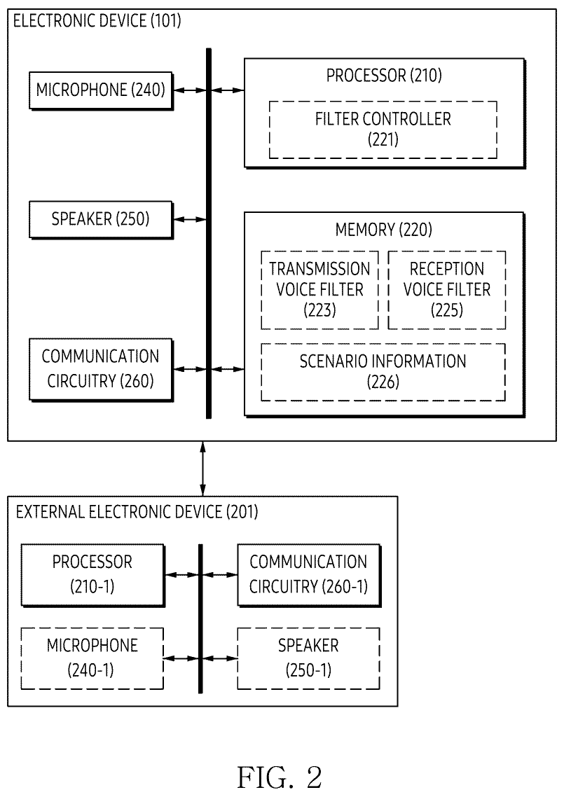

FIG. 2 illustrates an example of a block diagram of an electronic device, according to an embodiment of the disclosure.

An electronic device 101 of FIG. 2 may include a personal computer (PC) such as a laptop and a desktop, a smartphone, a smartpad, a tablet PC, and a smart accessory such as a smartwatch and a head-mounted device (HMD). The electronic device 101 of FIG. 2 may include the electronic device 101 of FIG. 1.

Referring to FIG. 2, the electronic device 101 according to an embodiment may include at least one of a processor 210, memory 220, a microphone 240, a speaker 250, or communication circuitry 260. The processor 210, the memory 220, the microphone 240, the speaker 250, and the communication circuitry 260 may, for example, be electronically and/or operably coupled with each other by an electronical component such as a communication bus. In an embodiment, hardware of the electronic device 101 being operably coupled may mean that a direct connection or an indirect connection is established between the hardware by wire or wirelessly, such that a second hardware is controlled by first hardware among the hardware. Although illustrated based on different blocks, an embodiment is not limited thereto, and at least a portion (e.g., the at least a portion of the processor 210, the memory 220, and the communication circuitry 260) of the hardware of FIG. 2 may be included in a single integrated circuit such as a system on a chip (SoC). A type and/or the number of the hardware included in the electronic device 101 is not limited to what is illustrated in FIG. 2. For example, the electronic device 101 may include only a portion of the hardware components illustrated in FIG. 2.

According to an embodiment, the processor 210 of the electronic device 101 may include hardware for processing data based on one or more instructions. The hardware for processing data may include, for example, an arithmetic and logic unit (ALU), a floating point unit (FPU), a field programmable gate array (FPGA), a central processing unit (CPU) and/or an application processor (AP). The number of processors 210 may be one or more. For example, the processor 210 may have a structure of a multi-core processor such as a dual core, a quad core, or a hexa core. The processor 210 of FIG. 2 may include the processor 120 of FIG. 1.

According to another embodiment, the memory 220 of the electronic device 101 may include a hardware component for storing data and/or instructions inputted to and/or outputted from the processor 210. The memory 220 may include, for example, a volatile memory such as a random-access memory (RAM) and/or a non-volatile memory such as a read-only memory (ROM). The volatile memory may include, for example, at least one of a dynamic RAM (DRAM), a static RAM (SRAM), a cache RAM, or a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, a solid state drive (SSD), or an embedded multimedia card (eMMC). The memory 220 of FIG. 2 may include the memory 130 of FIG. 1.

The speaker 240 of the electronic device 101 may output an audio signal. For example, the electronic device 101 may receive audio data from an external device (e.g., a server, a smartphone, a PC, a personal digital assistant (PDA), or an access point). The electronic device 101 may output the received audio data using the speaker 240. For example, the speaker 240 may receive an electrical signal. For example, the speaker 240 may convert the electrical signal into a sound wave signal. For example, the speaker 240 may output an audio (or voice) signal including the converted sound wave signal.

The microphone 150 of the electronic device 101 according to an embodiment may receive an audio (or voice) signal from the outside. For example, the electronic device 101 may include one or more microphones. For example, the electronic device 101 may dispose the microphone 240 in a portion of a housing of the electronic device 101. As an example, the microphone 240 may be referred to as a feed forward microphone on a lateral surface disposed toward the outside of the electronic device 101.

In an embodiment, the communication circuitry 260 of the electronic device 101 may include a hardware component for supporting transmission and/or reception of an electrical signal between the electronic device 101 and an external electronic device 201. The communication circuitry 260 may include, for example, at least one of a MODEM, an antenna, or an optic/electronic (O/E) converter. The communication circuitry 260 may support transmission and/or reception of an electrical signal based on various types of protocols such as ethernet, a local area network (LAN), a wide area network (WAN), wireless fidelity (Wi-Fi), Bluetooth, Bluetooth low energy (BLE), ZigBee, long term evolution (LTE), 5G new radio (NR) and/or sixth generation (6G).

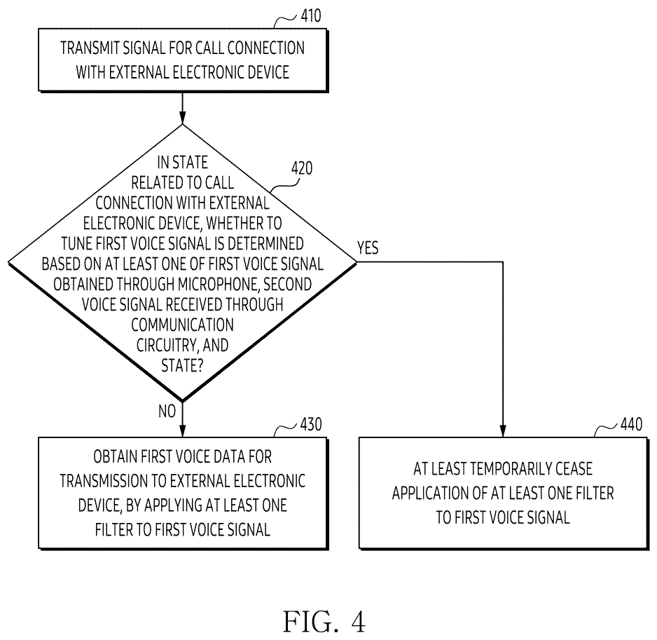

In the memory 220 of the electronic device 101, one or more instructions (or commands) indicating a computation and/or an operation to be performed by the processor 210 on data may be stored. A set of one or more instructions may be referred to as firmware, an operating system, a process, a routine, a sub-routine, and/or an application. For example, the electronic device 101 and/or the processor 210 may perform at least one of operations of FIGS. 4 to 10 when a set of a plurality of instructions distributed in the form of an operating system, firmware, a driver, and/or an application is executed.

The electronic device 101 according to an embodiment may obtain a voice signal through the microphone 240 while maintaining a call connection with the external electronic device 201. The electronic device 101 may tune the voice signal before transmitting the voice signal to the external electronic device 201 through the communication circuitry 260. The electronic device 101 may perform tuning to mitigate a noise portion included in the voice signal or to enhance a voice portion. The electronic device 101 may perform tuning of the voice signal through a transmission voice filter 223. In an example, the transmission voice filter 223 may include one or more filters for changing at least a portion of the received voice signal. For example, the transmission voice filter 223 may include a filter for mitigating a noise portion and/or a filter for enhancing a voice portion. The electronic device 101 may perform the tuning for changing at least a portion of the voice signal through the transmission voice filter 223. The electronic device 101 may transmit the tuned voice signal to the external electronic device 201 through the communication circuitry 260.

For example, the electronic device 101 may receive a voice signal from the external electronic device 201 through the communication circuitry 260 while maintaining the call connection with the external electronic device 201, using a reception voice filter 225. The electronic device 101 may change at least a portion of the voice signal before outputting the voice signal through the speaker 250. The electronic device 101 may tune the voice signal by applying the reception voice filter 225 to the voice signal such that the voice signal has a stereo or mono format. The electronic device 101 may output the tuned voice signal through the speaker 250.

The electronic device 101 may determine whether to apply the transmission voice filter 223 to a first voice signal obtained through the microphone 240, using a filter controller 221. The electronic device 101 may determine whether to apply the reception voice filter 225 to a second voice signal received through the communication circuitry 260. The electronic device 101 may activate or deactivate the application for the transmission voice filter 223 and/or the reception voice filter 225 using the filter controller 221. The electronic device 101 may, for example, determine whether to apply the transmission voice filter 223 and/or the reception voice filter 225 using at least one of the first voice signal, the second voice signal, and/or a state indicating the call connection with the external electronic device 201. The electronic device 101 may identify whether to tune the first voice signal and/or the second voice signal by controlling the filter controller 221 using scenario information 226 indicating information on the first voice signal, the second voice signal, and/or the state related to the call connection with the external electronic device 201. The scenario information 226 may include information on a state related to the call connection (e.g., a state of transmitting a request signal for the call connection), a type of the first voice signal (e.g., whether it includes noise), and a state of the speaker 250 (or an earbud) for outputting the second voice signal. When the electronic device 101 corresponds to at least one scenario included in the scenario information 226, it may at least temporarily cease an operation of tuning the voice signal using the transmission voice filter 223 and/or the reception voice filter 225.

Referring to FIG. 2, in an embodiment, the external electronic device 201 may include at least one of a processor 210-1, a microphone 240-1, a speaker 250-1, or communication circuitry 260-1. In the external electronic device 201, the processor 210-1, the microphone 240-1, the speaker 250-1, and the communication circuitry 260-1 may be electronically and/or operably coupled with each other through a communication bus. The processor 210-1, the microphone 240-1, the speaker 250-1, and the communication circuitry 260-1 included in the external electronic device 201 may include hardware components and/or circuitry corresponding to the processor 210, the microphone 240, the speaker 250, and the communication circuitry 260 of the electronic device 101. To reduce repetition, a description of the processor 210-1, the microphone 240-1, the speaker 250-1, and the communication circuitry 260-1 may be omitted to the extent that it overlaps with the description of the processor 210, the microphone 240, the speaker 250, and the communication circuitry 260 in the electronic device 101. The external electronic device 201 may, for example, transmit a voice signal received through the microphone 240-1 to the electronic device 101 while establishing a call connection with the electronic device 101 through the communication circuitry 260-1.

As described above, the electronic device 101 according to an embodiment may identify whether to use at least one filter for tuning a voice signal by controlling the filter controller 221 in a state related to a call connection with the external electronic device 201. The electronic device 101 may reduce an amount of computation for tuning the voice signal when it at least temporarily ceases applying at least one filter to the voice signal using the scenario information 226. Based on the reduction in the amount of computation for tuning the voice signal, the electronic device 101 may reduce clock consumption of the processor 210. Based on the reduction in the clock consumption of the processor 210, the electronic device 101 may reduce current consumption of a battery.

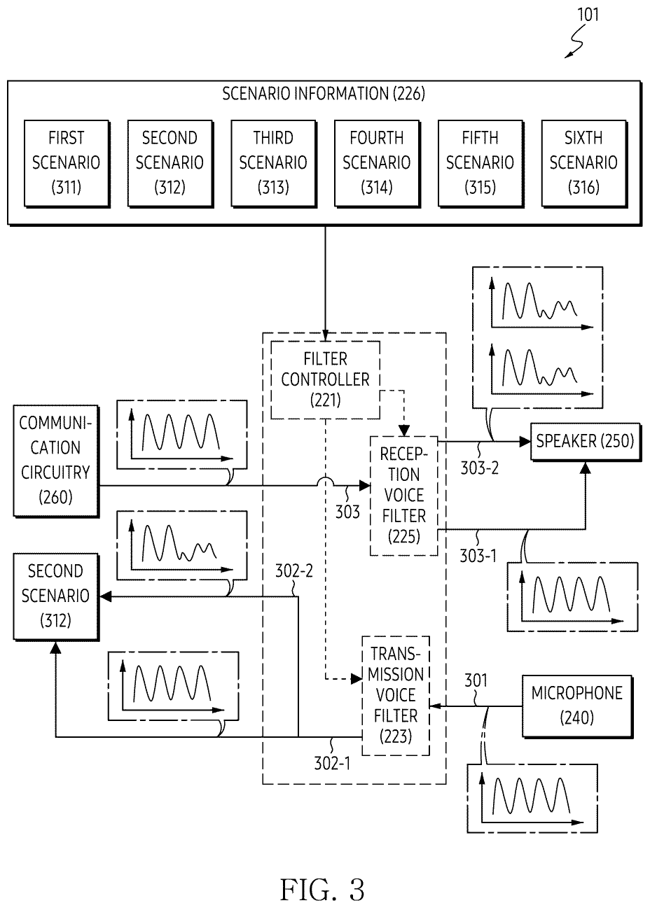

FIG. 3 illustrates an example of an operation in which an electronic device determines whether to perform tuning of a voice signal, according to an embodiment of the disclosure.

An electronic device 101 of FIG. 3 may include the electronic device 101 of FIGS. 1 to 2.

Referring to FIG. 3, the electronic device 101 according to an embodiment may obtain a first voice signal 301 through a microphone 240 in a state related to a call connection with an external electronic device (e.g., the external electronic device 201 of FIG. 2). In an example, in the state, the electronic device 101 may receive a second voice signal 303 (or voice data indicating the second voice signal) from the external electronic device through communication circuitry 260. For example, the electronic device 101 may identify whether to tune the first voice signal 301 and/or the second voice signal 303 by controlling a filter controller 221 using scenario information 226.

When the electronic device 101 according to an embodiment fails to identify one or more scenarios included in the scenario information 226, it may tune the first voice signal 301 and/or the second voice signal 303. Referring to FIG. 1, six scenarios information (a first scenario 311 to a sixth scenario 316) related to tuning the first voice signal 301 and/or the second voice signal 303 are illustrated. The number of scenario information illustrated in FIG. 1 is not limited to the six scenarios shown in FIG. 1. For example, the electronic device 101 may tune the first voice signal 301 through a transmission voice filter 223 while maintaining the call connection with the external electronic device. The electronic device 101 may obtain a tuning signal 302-2 in which a noise portion included in the first voice signal 301 is mitigated or a voice portion is enhanced, by changing at least a portion of the first voice signal 301. The electronic device 101 may transmit voice data indicating the tuning signal 302-2 to the external electronic device through the communication circuitry 206. For example, a first frequency included in the first voice signal 301 may be at least partially different from a second frequency included in the tuning signal 302-2. The electronic device 101 may change the first voice signal having the first frequency to voice data corresponding to the tuning signal 302-2 having the second frequency by applying at least one filter (e.g., the transmission voice filter 223).

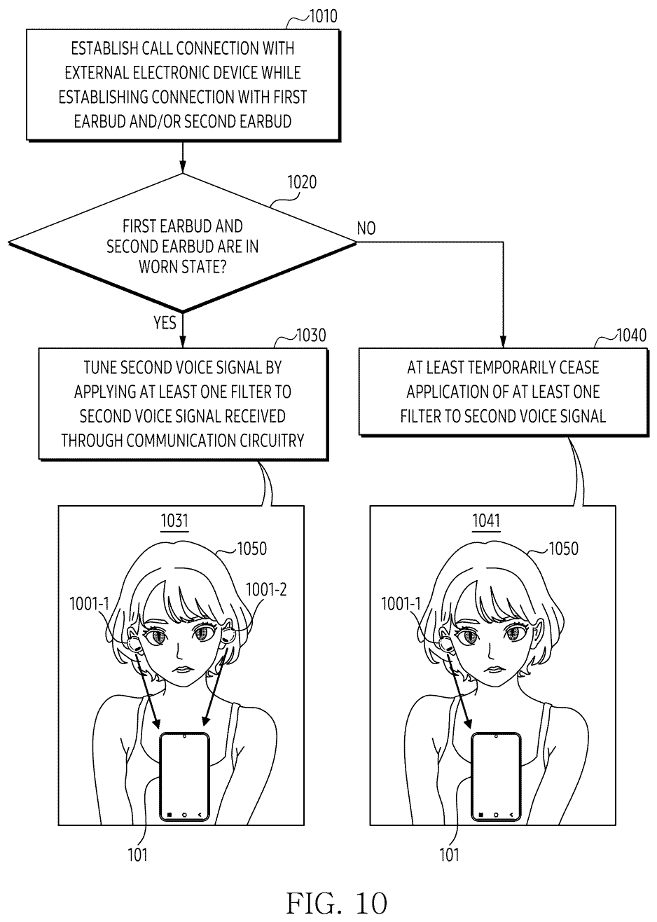

The electronic device 101 may tune the second voice signal 303 received through the communication circuitry 260 through a reception voice filter 225. For example, the electronic device 101 may obtain a tuning signal 303-2 having a stereo format by tuning the second voice signal 303. The electronic device 101 may output voice data indicating the tuning signal 303-2 through a speaker 250. However, it is not limited thereto. As an example, when the electronic device 101 is connected to an earbud, it may output the voice data through the earbud. An operation in which the electronic device 101 uses an earbud will be described later with reference to FIG. 10.

When the electronic device 101 according to an embodiment identifies at least one of the one or more scenarios included in the scenario information 226, it may at least temporarily cease tuning of the first voice signal 301 and/or the second voice signal 303.

For example, the scenario information 226 may include information on a state related to a call connection, the first voice signal 301, and/or the second voice signal 303 each mapped to the one or more scenarios. For example, the first scenario 311 (or first scenario information) may include a state of a call connection related to an automated response system (ARS). The first scenario 311 may be identified using information included in the second voice signal 303. The electronic device 101 may identify the first scenario 311 based on identifying the second voice signal 303 indicating a machine tone. The electronic device 101 may identify the first scenario 311 based on verifying a preset telephone number indicating ARS. The first scenario 311 may include a list of preset telephone numbers indicating ARS.

For example, based on identifying the first scenario 311, the electronic device 101 may deactivate processing of the transmission voice filter 223 by controlling the filter controller 221. The electronic device 101 may turn off the transmission voice filter 223 by controlling the filter controller 221. For example, the electronic device 101 may at least temporarily cease applying the transmission voice filter 223 to the first voice signal 301. Since it is not necessary to enhance a voice portion included in the first voice signal 301 in the call connection state related to ARS, the electronic device 101 may at least temporarily refrain from tuning the first voice signal 301. However, it is not limited thereto.

The electronic device 101 may identify a second scenario 312 (or second scenario information) indicating a state related to a call connection, for a preset time from transmitting a request signal for establishing the call connection to the external electronic device until the call connection is established. The electronic device 101 may identify the second scenario 312 based on identifying audio data (e.g., the second voice signal 303) indicating a ring back tone. Based on identifying the ring back tone, the electronic device 101 may at least temporarily cease tuning of the first voice signal 301. The electronic device 101 may at least temporarily cease applying the transmission voice filter 223 to the first voice signal 301 by controlling the filter controller 221. Based on identifying the second scenario 312, the electronic device 101 may at least temporarily cease tuning of the first voice signal 301 based on at least temporarily deactivating processing of the transmission voice filter 223.

For example, the electronic device 101 may identify the first voice signal 301 including noise through the microphone 240 while maintaining the call connection established with the external electronic device. The electronic device 101 may identify a third scenario 313 (or third scenario information) when the first voice signal 301 includes a noise portion less than a preset threshold. Since it is not necessary to mitigate the noise portion when the first voice signal 301 includes the noise portion less than the preset threshold, the electronic device 101 may at least temporarily defer tuning for removing (or mitigating) the noise included in the first voice signal 301. Based on identifying the third scenario, the electronic device 101 may at least temporarily cease tuning of the first voice signal 301 by controlling the filter controller 221 to deactivate a block for removing noise included in the transmission voice filter 223.

In an example, the electronic device 101 may identify a fourth scenario 314 based on identifying an input for at least temporarily ceasing transmission of voice data to the external electronic device while establishing a call connection with the external electronic device (e.g., the external electronic device 201 of FIG. 2). The input for at least temporarily ceasing transmission of the voice data may include an input for muting. Since the electronic device 101 does not transmit the voice data to the external electronic device through the communication circuitry 260 based on identifying the input, it may at least temporarily refrain from tuning the first voice signal 301.

The electronic device 101 may establish a call connection with a plurality of external electronic devices. The electronic device 101 may establish the call connection with the plurality of external electronic devices based on push to talk (PTT). The PTT may mean a call connected between the electronic device 101 and the plurality of external electronic devices and is based on a one-way direction. When the call connection is established based on the PTT, the electronic device 101 may transmit voice data to the plurality of external electronic devices while receiving an input for transmitting the voice data (or while the input is maintained). When the input is not received, the electronic device 101 may output a voice signal obtained from the plurality of external electronic devices. When the input is not received, the electronic device 101 may identify a fifth scenario 315. Since the electronic device 101 does not transmit voice data for the first voice signal 301 to the plurality of external electronic devices when the input is not received, it may at least temporarily cease tuning of the first voice signal 301.

The electronic device 101 may at least partially refrain from performing an operation using the transmission voice filter 223 by controlling the filter controller 221, based on identifying the first scenario 311 to the fifth scenario 315 included in the scenario information 226. In a state related to a call connection with the external electronic device (or with the plurality of external electronic devices), the electronic device 101 may at least temporarily cease tuning of the first voice signal 301 received through the microphone 240 based on identifying at least one of the first scenario 311 to the fifth scenario 315. The first scenario 311 to the sixth scenario 316 may be identified independently. Based on at least temporarily ceasing tuning of the first voice signal 301, the electronic device 101 may obtain first voice data 302-1 corresponding to the first voice signal 301 and to be transmitted to the external electronic device. For example, the electronic device 101 may change the first voice signal 301 having the first frequency to the first voice data 302-1 having the first frequency. As another example, when the electronic device 101 receives an input for at least temporarily blocking transmission of voice data to the external electronic device (e.g., the fourth scenario), the electronic device 101 may temporarily cease obtaining the first voice data 302-1 corresponding to the first voice signal 301. However, it is not limited thereto.

In a state in which the electronic device 101 according to an embodiment is connected to a plurality of earbuds, it may output the second voice signal 303 received from the external electronic device (e.g., the external electronic device 201 of FIG. 2) through the earbuds while maintaining a call connection with the external electronic device. The electronic device 101 may identify a wearing state of the plurality of earbuds. The electronic device 101 may identify a state in which one of the plurality of earbuds is worn or a state in which all of the plurality of earbuds are worn. The electronic device 101 may identify the sixth scenario 316 according to the identified wearing state. Since it is unnecessary to tune the second voice signal 303 based on a binaural format in the state in which one earbud is worn, the electronic device 101 may transmit second voice data 303-1 having a mono format to the one earbud. The electronic device 101 may obtain the second voice data 303-1 corresponding to the second voice signal 303, based on deactivating at least a portion of the reception voice filter 225 for changing the second voice signal 303 to a binaural format by controlling the filter controller 221. However, it is not limited thereto.

As described above, the electronic device 101 according to an embodiment may at least partially cease performing an operation related to the reception voice filter 225 and/or the transmission voice filter 223 by controlling the filter controller 221, based on identifying at least one of the plurality of scenarios included in the scenario information 226. Based on at least partially ceasing the performance of the operation related to the reception voice filter 225 and/or the transmission voice filter 223, the electronic device 101 may at least partially cease tuning of the first voice signal 301 and/or the second voice signal 303. Since the electronic device 101 at least partially ceases tuning of the first voice signal 301 and/or the second voice signal 303, the current consumed for processing the operation related to the reception voice filter 225 and/or the transmission voice filter 223 may be reduced.

FIG. 4 illustrates an example of a flowchart indicating an operation of an electronic device, according to an embodiment of the disclosure.

An electronic device 101 of FIG. 4 may include the electronic device 101 of FIG. 1. At least one of operations of FIG. 4 may be performed by the electronic device 101 of FIG. 1 and/or the processor 210 of FIG. 2. Each of the operations of FIG. 4 may be performed sequentially, but is not necessarily performed sequentially. For example, an order of each of the operations may be changed, and at least two operations may be performed in parallel.

Referring to FIG. 4, in operation 410, a processor according to an embodiment may transmit a signal for a call connection with an external electronic device. Based on transmitting the signal, the processor may identify a state related to the call connection with the external electronic device. Based on identifying the state related to the call connection, the processor may identify at least one of one or more scenarios included in scenario information (e.g., the scenario information 226 of FIG. 2).

Referring to FIG. 4, in operation 420, in the state related to the call connection with the external electronic device, the processor according to an embodiment may determine whether to tune a first voice signal based on at least one of the first voice signal obtained through a microphone, a second voice signal received through communication circuitry, and the state. For example, the processor may at least temporarily refrain from tuning the first voice signal and/or the second voice signal, based on identifying at least one of the one or more scenarios included in the scenario information (e.g., the scenario information 226 of FIG. 2).

For example, from transmitting a signal requesting the call connection to the external electronic device until the call connection is successfully established, the processor may determine whether to tune the first voice signal, based on identifying a second scenario (e.g., the second scenario 312 of FIG. 3). After establishing the call connection, in the state related to ARS, the processor may determine whether to tune the first voice signal, based on identifying a first scenario (e.g., the first scenario 311 of FIG. 3). The processor may, for example, identify a third scenario (e.g., the third scenario 313 of FIG. 3) based on identifying the first voice signal including a noise portion less than a preset threshold. Based on identifying the third scenario, the processor may determine whether to perform tuning of the first voice signal. For example, the processor may identify a fourth scenario (e.g., the fourth scenario 314 of FIG. 3) based on receiving an input for at least temporarily refraining from transmitting first voice data corresponding to the first voice signal to the external electronic device while maintaining the call connection. Based on identifying the fourth scenario, the processor may at least temporarily cease (or refrain from) applying at least one filter (e.g., the transmission voice filter 223 of FIG. 3) to the first voice signal received through the microphone. In a state in which the call connection is established with a plurality of external electronic devices based on push to talk (PTT), the processor may obtain voice data indicating a tuning signal (e.g., the tuning signal 302-2 of FIG. 3) by applying at least one filter (e.g., the transmission voice filter 223 of FIG. 3) to the first voice signal while an input for transmitting the voice data to the plurality of external electronic devices is maintained. Based on identifying a fifth scenario (e.g., the fifth scenario 315 of FIG. 3) while the input is not maintained, the processor may at least temporarily cease the application of the at least one filter to the first voice signal.

Referring to FIG. 4, when tuning the first voice signal (operation 420—YES), in operation 430, the processor according to an embodiment may obtain first voice data for transmission to the external electronic device, by applying at least one filter to the first voice signal. When the processor fails to identify at least one of the one or more scenarios included in the scenario information (e.g., the scenario information 226 of FIG. 2), it may activate at least one filter (e.g., the transmission voice filter 223 and/or the reception voice filter 225) by controlling a filter controller (e.g., the filter controller 221 of FIG. 3). Activating at least one filter may include tuning the voice signal using the at least one filter. Tuning the voice signal may include changing at least a portion of frequencies included in the voice signal. For example, the processor may improve call quality related to the call connection based on tuning the voice signal.

Referring to FIG. 4, when not tuning the first voice signal (operation 420—NO), in operation 440, the processor according to an embodiment may at least temporarily cease the application of the at least one filter to the first voice signal. For example, the processor may deactivate at least one filter (e.g., the reception voice filter 225 and/or the transmission voice filter 223) by controlling the filter controller (e.g., the filter controller 221 of FIG. 3), based on identifying at least one of the one or more scenarios included in the scenario information. Deactivating at least one filter may, for example, include temporarily ceasing tuning of the voice signal before transmitting the voice signal to the external electronic device or before outputting the voice signal through a speaker. For example, based on deactivating the at least one filter, the processor may at least temporarily cease applying the at least one filter to the voice signal received through the microphone. Based on at least temporarily ceasing the application of the at least one filter, the processor may transmit voice data substantially similar to the voice signal to the external electronic device. However, it is not limited thereto. The processor may reduce current consumption for processing the voice signal and maintain call quality by at least partially refraining from processing the voice signal, based on identifying at least one of the one or more scenarios using the scenario information.

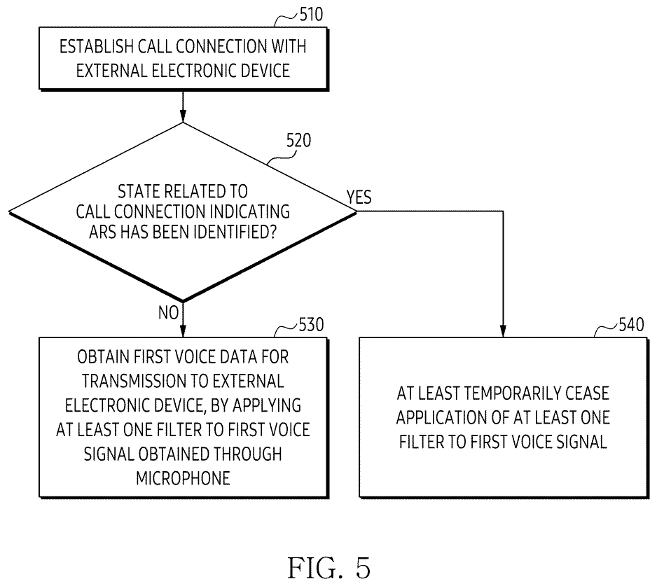

FIG. 5 illustrates an example of a flowchart indicating an operation in which an electronic device determines tuning of a voice signal based on identifying a state related to a call connection, according to an embodiment of the disclosure.

An electronic device 101 of FIG. 5 may include the electronic device 101 of FIG. 1. At least one of operations of FIG. 5 may be performed by the electronic device 101 of FIG. 1 and/or the processor 210 of FIG. 2. Each of the operations of FIG. 5 may be performed sequentially, but is not necessarily performed sequentially. For example, an order of each of the operations may be changed, and at least two operations may be performed in parallel. At least one of the operations of FIG. 5 may be related to at least one of the operations of FIG. 4.

Referring to FIG. 5, in operation 510, a processor according to an embodiment may establish a call connection with an external electronic device. The processor may establish the call connection through an incoming call received from the external electronic device. The processor may, for example, establish the call connection through an outgoing call transmitted to the external electronic device. Based on establishing the call connection, the processor may obtain a first voice signal (e.g., the first voice signal 301 of FIG. 3) through a microphone and/or a second voice signal (e.g., the second voice signal 303 of FIG. 3) from the external electronic device through communication circuitry. The processor may identify at least one (e.g., the first scenario 311 of FIG. 3) of one or more scenarios included in scenario information (e.g., the scenario information 226 of FIG. 2), based on a state related to the call connection, the first voice signal, and/or the second voice signal.

Referring to FIG. 5, in operation 520, the processor according to an embodiment may verify whether a state related to the call connection indicating ARS has been identified. The processor may identify the state indicating ARS when the call connection is established with the external electronic device corresponding to a preset telephone number (e.g., a telephone number indicating ARS). The processor may identify the state based on identifying the second voice signal indicating a machine tone. However, it is not limited thereto. For example, the processor may identify the first scenario (e.g., the first scenario 311 of FIG. 3) based on identifying the state.

Referring to FIG. 5, when the state is not related to the call connection indicating ARS (operation 520—NO), in operation 530, the processor according to an embodiment may obtain first voice data for transmission to the external electronic device, by applying at least one filter to the first voice signal obtained through the microphone. For example, when the processor fails to identify at least one of the one or more scenarios included in scenario information (e.g., the scenario information 226 of FIG. 2), it may tune the first voice signal by controlling a filter controller (e.g., the filter controller 221 of FIG. 3) to apply at least one filter (e.g., a transmission voice filter 223 and/or a reception voice filter 225) to the first voice signal. The processor may, for example, transmit voice data indicating the tuned first voice signal to the external electronic device through the communication circuitry. However, it is not limited thereto. When the processor fails to identify at least one of the one or more scenarios included in the scenario information, it may tune the second voice signal received through the communication circuitry by applying the at least one filter to the second voice signal. The processor may output the tuned second voice signal through a speaker.

Referring to FIG. 5, when the state related to the call connection indicating ARS is identified (operation 520—YES), in operation 540, the processor according to an embodiment may at least temporarily cease the application of the at least one filter to the first voice signal. The processor may deactivate at least one filter (e.g., the transmission voice filter 223) by controlling the filter controller (e.g., the filter controller 221 of FIG. 3), based on identifying at least one (e.g., the first scenario 311 of FIG. 3) of the one or more scenarios included in the scenario information. Deactivating at least one filter may include at least temporarily ceasing tuning of the first voice signal before transmitting the first voice signal (e.g., the first voice signal 301 of FIG. 3) obtained through the microphone to the external electronic device. For example, the processor may at least temporarily cease the application of the at least one filter to the first voice signal received through the microphone, based on deactivating the at least one filter. Based on at least temporarily ceasing the application of the at least one filter, the processor may transmit first voice data indicating the first voice signal to the external electronic device. Since the processor at least temporarily ceases computational processing for tuning the first voice signal, it may reduce current consumption of a battery.

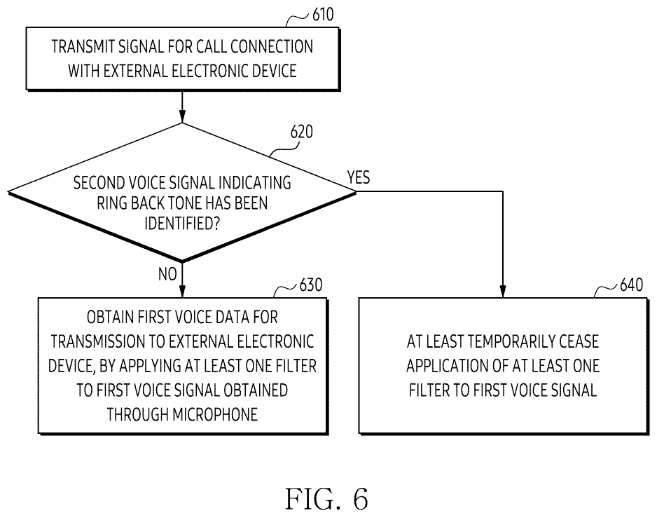

FIG. 6 illustrates an example of a flowchart indicating an operation in which an electronic device determines tuning of a voice signal based on identifying a ring back tone, according to an embodiment of the disclosure.

An electronic device 101 of FIG. 6 may include the electronic device 101 of FIG. 1. At least one of operations of FIG. 6 may be performed by the electronic device 101 of FIG. 1 and/or the processor 210 of FIG. 2. Each of the operations of FIG. 6 may be performed sequentially, but is not necessarily performed sequentially. For example, an order of each of the operations may be changed, and at least two operations may be performed in parallel. At least one of the operations of FIG. 6 may be related to at least one of the operations of FIG. 4.

Referring to FIG. 6, in operation 610, a processor according to an embodiment may establish a call connection with an external electronic device. The processor may request establishment of the call connection to the external electronic device, based on an outgoing call transmitted to the external electronic device. Before the call connection is established, the processor may obtain a first voice signal (e.g., the first voice signal 301 of FIG. 3) through a microphone. The processor may identify at least one (e.g., the second scenario 312 of FIG. 3) of one or more scenarios included in scenario information (e.g., the scenario information 226 of FIG. 2), based on a state in which the call connection has not been established (e.g., a call standby state), the first voice signal, and/or a second voice signal received through communication circuitry.

Referring to FIG. 6, in operation 620, the processor according to an embodiment may verify whether a second voice signal indicating a ring back tone has been identified. After transmitting a request signal for an outgoing call to the external electronic device, the processor may identify the second voice signal indicating the ring back tone for a preset time. The processor may identify the second voice signal indicating the ring back tone from transmitting the request signal until the call connection is successfully established. The processor may identify the second scenario (e.g., the second scenario 312 of FIG. 3) among scenario information (e.g., the scenario information 262 of FIG. 2) based on identifying the second voice signal indicating the ring back tone.

Referring to FIG. 6, when the second voice signal indicating the ring back tone is not identified (operation 620—NO), in operation 630, the processor according to an embodiment may obtain first voice data for transmission to the external electronic device, by applying at least one filter to the first voice signal obtained through the microphone. A case in which the second voice signal is not identified may include a case in which the call connection between the electronic device and the external electronic device is successfully established. The first voice data may correspond to a tuning signal (e.g., the tuning signal 302-2 of FIG. 3) in which at least a portion is changed from the first voice signal. For example, when the processor fails to identify at least one (e.g., the second scenario 312 of FIG. 3) of the one or more scenarios included in the scenario information (e.g., the scenario information 226 of FIG. 2), it may tune the first voice signal by controlling a filter controller (e.g., the filter controller 221 of FIG. 3) to apply at least one filter (e.g., a transmission voice filter 223 and/or a reception voice filter 225) to the first voice signal. The processor may transmit the first voice data indicating the tuned first voice signal to the external electronic device through the communication circuitry. However, it is not limited thereto. When the processor fails to identify at least one of the one or more scenarios included in the scenario information, it may tune the second voice signal by applying at least one filter (e.g., the reception voice filter 225 of FIG. 2) to the second voice signal received through the communication circuitry. The processor may output the tuned second voice signal through a speaker.

Referring to FIG. 6, when the second voice signal indicating the ring back tone is identified (operation 620—YES), in operation 640, the processor according to an embodiment may at least temporarily cease the application of the at least one filter to the first voice signal. For example, the processor may deactivate at least one filter (e.g., the transmission voice filter 223) by controlling the filter controller (e.g., the filter controller 221 of FIG. 3), based on identifying at least one (e.g., the second scenario 312 of FIG. 3) of the one or more scenarios included in the scenario information. For example, when the at least one scenario (e.g., the second scenario 312 of FIG. 3) is identified, the processor may at least temporarily refrain from tuning the voice signal since the voice signal may not be transmitted to the external electronic device. Deactivating at least one filter may include temporarily ceasing tuning of the first voice signal before transmitting the first voice signal (e.g., the first voice signal 301 of FIG. 3) obtained through the microphone to the external electronic device. Tuning the first voice signal may include an operation of enhancing or mitigating a portion included in the first voice signal. In an example, the processor may at least temporarily cease the application of the at least one filter to the first voice signal received through the microphone, based on deactivating the at least one filter. Based on at least temporarily ceasing the application of the at least one filter, the processor may transmit first voice data indicating the first voice signal to the external electronic device.

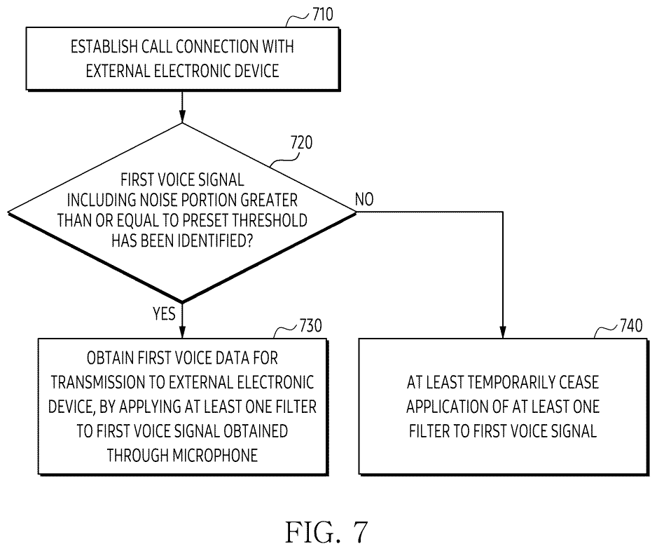

FIG. 7 illustrates an example of a flowchart indicating an operation in which an electronic device determines tuning of a voice signal based on identifying noise, according to an embodiment of the disclosure.

An electronic device 101 of FIG. 7 may include the electronic device 101 of FIG. 1. At least one of operations of FIG. 7 may be performed by the electronic device 101 of FIG. 1 and/or the processor 210 of FIG. 2. Each of the operations of FIG. 7 may be performed sequentially, but is not necessarily performed sequentially. For example, an order of each of the operations may be changed, and at least two operations may be performed in parallel. At least one of the operations of FIG. 7 may be related to at least one of the operations of FIG. 4.

Referring to FIG. 7, in operation 710, a processor according to an embodiment may establish a call connection with an external electronic device. For example, the processor may establish the call connection based on an incoming call received from the external electronic device. The processor may, for example, establish the call connection based on an outgoing call transmitted to the external electronic device. Based on establishing the call connection, the processor may obtain a first voice signal (e.g., the first voice signal 301 of FIG. 3) through a microphone and/or a second voice signal (e.g., the second voice signal 303 of FIG. 3) from the external electronic device through communication circuitry. The processor may identify at least one (e.g., the third scenario 313 of FIG. 3) of one or more scenarios included in scenario information (e.g., the scenario information 226 of FIG. 2), based on a state related to the call connection, the first voice signal, and/or the second voice signal.

Referring to FIG. 7, in operation 720, the processor according to an embodiment may verify whether the first voice signal including a noise portion greater than or equal to a preset threshold has been identified. The processor may analyze noise included in the first voice signal. The processor may identify whether the first voice signal includes a noise portion greater than or equal to the preset threshold. The noise portion may include a portion excluding a voice portion included in the first voice signal. A frequency corresponding to the voice portion and a frequency corresponding to the noise portion may be different.

Referring to FIG. 7, when the first voice signal including noise greater than or equal to the preset threshold is identified (operation 720—YES), in operation 730, the processor according to an embodiment may obtain first voice data for transmission to the external electronic device, by applying at least one filter to the first voice signal obtained through the microphone. The first voice data may correspond to a tuning signal (e.g., the tuning signal 302-2 of FIG. 3) in which at least a portion (e.g., the noise portion) is mitigated from the first voice signal. For example, when the processor fails to identify at least one (e.g., the third scenario 313 of FIG. 3) of the one or more scenarios included in the scenario information (e.g., the scenario information 226 of FIG. 2), it may tune the first voice signal by controlling a filter controller (e.g., the filter controller 221 of FIG. 3) to apply at least one filter (e.g., a transmission voice filter 223) to the first voice signal. The processor may tune the first voice signal by using the at least one filter that generates another frequency to offset the frequency corresponding to the noise portion. The processor may, for example, transmit the first voice data indicating the tuned first voice signal to the external electronic device through communication circuitry. An operation of tuning the first voice signal may be referred to as noise canceling.

For example, when the processor fails to identify at least one of the one or more scenarios included in the scenario information, it may tune the second voice signal by applying at least one filter (e.g., the reception voice filter 225 of FIG. 2) to the second voice signal received through the communication circuitry. The processor may output the tuned second voice signal through a speaker.

Referring to FIG. 7, when the first voice signal including a noise portion less than the preset threshold is identified (operation 720—NO), in operation 740, the processor according to an embodiment may at least temporarily cease applying the at least one filter to the first voice signal.

For example, the processor may refrain from performing an operation using at least one filter (e.g., the transmission voice filter 223) by controlling the filter controller (e.g., the filter controller 221 of FIG. 3), based on identifying at least one (e.g., the third scenario 313 of FIG. 3) of the one or more scenarios included in the scenario information. The processor may at least temporarily cease tuning of the first voice signal using the at least one filter before transmitting the first voice signal (e.g., the first voice signal 301 of FIG. 3) obtained through the microphone to the external electronic device. Tuning the first voice signal may include an operation of mitigating the noise portion included in the first voice signal. The processor may at least temporarily cease applying the at least one filter to the first voice signal including noise less than the preset threshold, based on deactivating the at least one filter. The processor may obtain first voice data indicating the first voice signal including noise less than the preset threshold. For example, when the first voice signal including a noise portion less than the preset threshold is identified, the electronic device may bypass processing for mitigating the noise portion. The processor may change the first voice signal to the first voice data by bypassing the at least one filter (e.g., the transmission voice filter 223), and transmit the changed first voice data to the external electronic device. Based on bypassing the at least one filter, he processor may reduce clock consumption for performing an operation of using the at least one filter.

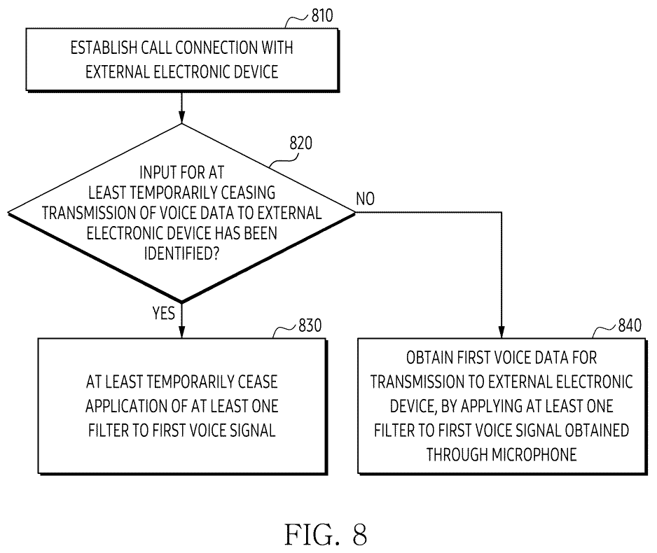

FIG. 8 illustrates an example of a flowchart indicating an operation in which an electronic device determines tuning of a voice signal based on identifying a preset input, according to an embodiment of the disclosure.

An electronic device 101 of FIG. 8 may include the electronic device 101 of FIG. 1. At least one of operations of FIG. 8 may be performed by the electronic device 101 of FIG. 1 and/or the processor 210 of FIG. 2. Each of the operations of FIG. 8 may be performed sequentially, but is not necessarily performed sequentially. For example, an order of each of the operations may be changed, and at least two operations may be performed in parallel. At least one of the operations of FIG. 8 may be related to at least one of the operations of FIG. 4.

Referring to FIG. 8, in operation 810, a processor according to an embodiment may establish a call connection with an external electronic device. For example, the processor may establish the call connection based on an incoming call received from the external electronic device or an outgoing call transmitted to the external electronic device. Based on establishing the call connection, the processor may obtain a first voice signal (e.g., the first voice signal 301 of FIG. 3) through a microphone and/or a second voice signal (e.g., the second voice signal 303 of FIG. 3) from the external electronic device through communication circuitry. The processor may identify at least one (e.g., the third scenario 313 of FIG. 3) of one or more scenarios included in scenario information (e.g., the scenario information 226 of FIG. 2), based on a state related to the call connection, the first voice signal, and/or the second voice signal.

Referring to FIG. 8, in operation 820, the processor according to an embodiment may verify whether an input for at least temporarily ceasing transmission of voice data to the external electronic device has been identified. For example, the processor may display, on a display, a screen indicating a call while establishing the call connection. The processor may identify the input for an icon (e.g., an icon indicating mute) included in the screen for at least temporarily ceasing transmission of voice data. However, it is not limited thereto.

Referring to FIG. 8, when the input for at least temporarily ceasing the transmission of voice data is identified (operation 820—YES), in operation 830, the processor according to an embodiment may at least temporarily cease applying at least one filter to the first voice signal. In an example, based on identifying the input, the processor may identify at least one scenario (e.g., the fourth scenario 314 of FIG. 3) among the scenario information 226 of FIG. 2. As the transmission of voice data is at least temporarily ceased, the processor may at least temporarily refrain from tuning the first voice signal received through the microphone. The processor may at least temporarily refrain from tuning the first voice signal, based on bypassing at least one filter (e.g., a transmission voice filter 223) by controlling a filter controller. Since the processor does not perform computational processing on an operation using at least one filter by controlling the filter controller, current consumed for the computational processing may be reduced.

Referring to FIG. 8, when the input for at least temporarily ceasing the transmission of voice data is not identified (operation 820—NO), in operation 840, the processor according to an embodiment may obtain first voice data for transmission to the external electronic device, by applying at least one filter to the first voice signal obtained through the microphone. The processor may, for example, tune the first voice signal using the at least one filter for emphasizing a voice portion included in the first voice signal, in order to transmit the first voice data to the external electronic device. However, it is not limited thereto.

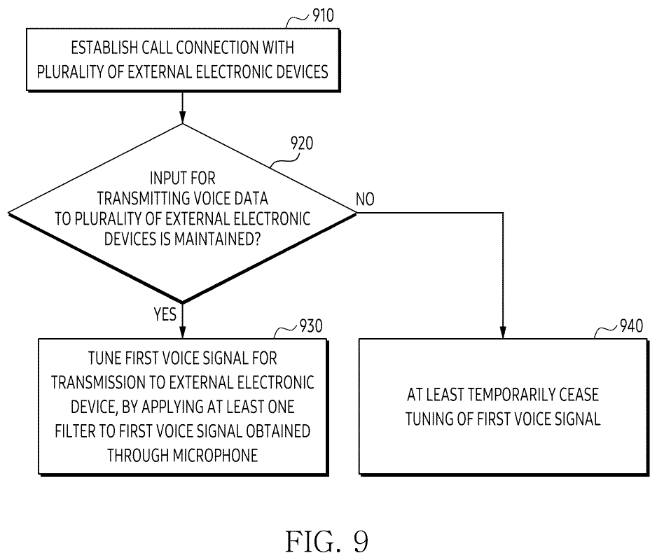

FIG. 9 illustrates an example of a flowchart indicating an operation in which an electronic device determines tuning of a voice signal based on establishing a call connection with a plurality of external electronic devices, according to an embodiment of the disclosure.

An electronic device 101 of FIG. 9 may include the electronic device 101 of FIG. 1. At least one of operations of FIG. 9 may be performed by the electronic device 101 of FIG. 1 and/or the processor 210 of FIG. 2. Each of the operations of FIG. 9 may be performed sequentially, but is not necessarily performed sequentially. For example, an order of each of the operations may be changed, and at least two operations may be performed in parallel. At least one of the operations of FIG. 9 may be related to at least one of the operations of FIG. 4.

Referring to FIG. 9, in operation 910, a processor according to an embodiment may establish a call connection with a plurality of external electronic devices. The plurality of external electronic devices may include the external electronic device 201 of FIG. 2. Based on establishing the call connection with the plurality of external electronic devices, the processor may provide a call network environment including the electronic device and the plurality of external electronic devices. The processor may, for example, establish the call connection with the plurality of external electronic devices based on push to talk (PTT).

Referring to FIG. 9, in operation 920, the processor according to an embodiment may identify whether an input for transmitting voice data to the plurality of external electronic devices is maintained. For example, when the call connection with the plurality of external electronic devices is established, the processor may transmit or receive voice data based on a direction between the electronic device and the plurality of external electronic devices. The processor may transmit voice data when the input is identified, and may receive other voice data from at least one of the plurality of external electronic devices when the input is not identified. However, it is not limited thereto.

Referring to FIG. 9, when the input for transmitting voice data is maintained (operation 920—YES), in operation 930, the processor according to an embodiment may tune a first voice signal for transmission to the external electronic device, by applying at least one filter to the first voice signal obtained through a microphone. The tuned first voice signal may correspond to a tuning signal (e.g., the tuning signal 302-2 of FIG. 3) in which at least a portion is changed from the first voice signal. The processor may tune the first voice signal by controlling a filter controller (e.g., the filter controller 221 of FIG. 3) to apply at least one filter (e.g., a transmission voice filter 223 and/or a reception voice filter 225) to the first voice signal. The processor may transmit the first voice data indicating the tuned first voice signal to the plurality of external electronic devices through communication circuitry. However, it is not limited thereto. The processor may refrain from tuning a second voice signal received through the communication circuitry by bypassing at least one filter (e.g., the reception voice filter 225 of FIG. 2) while identifying the input. The processor may at least temporarily cease tuning of the second voice signal since the processor does not output the second voice signal through a speaker while identifying the input. However, it is not limited thereto.

Referring to FIG. 9, when the input for transmitting voice data is not maintained (operation 920—NO), in operation 940, the processor according to an embodiment may at least temporarily cease tuning of the first voice signal. In an example, the processor may deactivate at least one filter (e.g., the transmission voice filter 223) by controlling the filter controller (e.g., the filter controller 221 of FIG. 3), based on identifying at least one (e.g., the fifth scenario 315 of FIG. 3) of one or more scenarios included in scenario information. For example, when the at least one scenario (e.g., the second scenario 312 of FIG. 3) is identified, the processor may at least temporarily refrain from tuning the voice signal since the voice signal may not transmitted to the plurality of external electronic devices. Deactivating at least one filter may include at least temporarily ceasing tuning of the first voice signal before transmitting the first voice signal (e.g., the first voice signal 301 of FIG. 3) obtained through the microphone to the plurality of external electronic devices. Tuning the first voice signal may include an operation of enhancing or mitigating a portion included in the first voice signal. The processor may at least temporarily cease the application of the at least one filter to the first voice signal received through the microphone, based on deactivating the at least one filter. While the input for transmitting voice data is not maintained, the processor may bypass at least one filter by controlling the filter controller, and may not tune the first voice signal and at least temporarily cease transmission of the first voice signal. For example, when the input for transmitting voice data is not maintained, the processor may tune the second voice signal (e.g., the second voice signal 303 of FIG. 3) received through the communication circuitry by applying at least one filter (e.g., the reception voice filter 225 of FIG. 2) to the second voice signal. When the input for transmitting voice data is not maintained, the processor may output the tuned second voice signal through the speaker. However, it is not limited thereto.

FIG. 10 illustrates an example of a flowchart indicating an operation in which an electronic device determines tuning of a voice signal received through communication circuitry based on a wearing state of an earbud, according to an embodiment of the disclosure.

An electronic device 101 of FIG. 10 may include the electronic device 101 of FIG. 1. At least one of operations of FIG. 10 may be performed by the electronic device 101 of FIG. 1 and/or the processor 210 of FIG. 2. Each of the operations of FIG. 10 may be performed sequentially, but is not necessarily performed sequentially. For example, an order of each of the operations may be changed, and at least two operations may be performed in parallel.

Referring to FIG. 10, in operation 1010, a processor according to an embodiment may establish a call connection with an external electronic device while establishing a connection (or communication connection) with a first earbud and/or a second earbud. While establishing a connection (or communication connection) with a first earbud 1001-1 and/or a second earbud 1001-2, the processor may output at least one voice data through the first earbud or the second earbud.

The first earbud 1001-1 and the second earbud 1001-2 may be configured as a pair. For example, a housing of the first earbud 1001-1 may have a form attachable to a left auricle of a user 1050. For example, a housing of the second earbud 1001-2 may have a form attachable to a right auricle of the user 1050. A wearable device 1001 may include a canal-type earbud and/or an open-type earbud.

For example, the processor may identify a posture of the first earbud 1001-1 and a posture of the second earbud 1001-2. A posture of the wearable device 1001 including the first earbud and the second earbud may be identified based on a form in which the wearable device 1001 is in contact with an external object (e.g., the user 1050), a position, and/or a direction to which a portion of the wearable device 1001 is facing.

The processor may establish a communication link with the wearable device 1001 using communication circuitry. For example, at least one of the first earbud 1001-1 or the second earbud 1001-2 may establish a communication link with the electronic device (e.g., the electronic device 101). An operation in which the wearable device 1001 obtains audio data via the communication link may include sniffing (or snooping). The sniffing may mean, for example, an operation in which the second earbud 1001-2 accesses a communication link between other electronic devices (e.g., the first earbud 101-1 and the electronic device 101) and obtains data transmitted or received via the communication link. The second earbud 1001-2 may output at least a portion of the obtained (or sniffed) audio data as an audio signal. However, it is not limited thereto.

The first earbud 1001-1 and the second earbud 1001-2 may each establish a communication link with the electronic device. The first earbud 1001-1 may transmit information (e.g., a vector value) indicating the posture of the first earbud 1001-1 to the electronic device via the communication link established with the electronic device. The second earbud 1001-2 may transmit information indicating the posture of the second earbud 1001-2 to the electronic device via the communication link established with the electronic device. The processor of the electronic device may identify a wearing state of the wearable device 1001 using the information indicating the posture of the first earbud 1001-1 and/or the information indicating the posture of the second earbud 1001-2. For example, the processor may identify the wearing state of the wearable device 1001 based on the communication link connected to the first earbud 1001-1 and/or the communication link connected to the second earbud 1001-2.

The processor may transmit audio data (e.g., voice data) being obtained in the electronic device 101 to the wearable device 1001. In terms of being able to control at least a portion of functions of the wearable device 1001, the electronic device 101 may be referred to as a primary device. For example, based on receiving data for audio from the electronic device 101, the wearable device 101 may output the data through a speaker of the wearable device 1001. For example, the wearable device 1001 may be referred to as a secondary device.

Referring to FIG. 10, in operation 1020, the processor according to an embodiment may identify whether the first earbud and the second earbud are in a worn state. The processor may identify whether the first earbud 1001-1 and the second earbud 1001-2 are in a state of being worn by the user 1050.

Referring to FIG. 10, in a state 1031 in which the first earbud 1001-1 and the second earbud 1001-2 are worn by the user 1050 (operation 1020—YES), in operation 1030, the processor according to an embodiment may tune a second voice signal by applying at least one filter to the second voice signal received through the communication circuitry. The processor may, for example, obtain a tuning signal corresponding to the first earbud 1001-1 and a tuning signal corresponding to the second earbud 1001-2 from the second voice signal through at least one filter (e.g., a reception voice filter 225). The processor may tune the second voice signal based on a binaural format. The tuning signal corresponding to the first earbud 1001-1 and the tuning signal corresponding to the second earbud 1001-2 may be included in the tuning signal 303-2 of FIG. 3. However, it is not limited thereto.

Referring to FIG. 10, in a state 1041 in which at least one of the first earbud and the second earbud is worn (operation 1020—NO), in operation 1040, the processor according to an embodiment may at least temporarily cease applying at least one filter to the second voice signal. In an example, the state 1041 may include a state in which the processor has identified the sixth scenario 316 of FIG. 3. In the state 1041, the processor of the electronic device 101 may deactivate at least one filter for changing the second voice signal to a binaural format (or a stereo format) since the processor only needs to output the second voice signal having a mono format. The processor may at least temporarily refrain from tuning the second voice signal by bypassing at least one filter (e.g., the reception voice filter 225 of FIG. 2) by controlling a filter controller. The processor may output second voice data (e.g., the second voice data 303-1 of FIG. 3) indicating the second voice signal through the first earbud 1001-1 or the second earbud 1001-2.

The electronic device according to an embodiment may determine whether to tune a voice signal received through the microphone according to a state related to a call connection, based on establishing the call connection with an external electronic device. The electronic device may reduce current consumption of a battery based on at least temporarily ceasing tuning of the voice signal. A method for the electronic device to determine whether to tune the voice signal may be required.

An electronic device 101 according to an embodiment as described above may comprise communication circuitry 260, a microphone 240, memory 220 for storing instructions, and at least one processor 210. When the instructions are executed, the at least one processor may be configured, in a first state related to a call connection with an external electronic device 201, based on at least one of a first voice signal 301 obtained through the microphone, a second voice signal 303 received through the communication circuitry, and the first state, to determine whether to tune the first voice signal. When the instructions are executed, the at least one processor may be configured, in a second state for tuning the first voice signal, to obtain first voice data for transmission to the external electronic device, by applying at least one filter 223 or 225 to the first voice signal. When the instructions are executed, the at least one processor may be configured, in a third state distinct from the second state, to at least temporarily cease the application of the at least one filter to the first voice signal.

In an example, when the instructions are executed, the at least one processor may be configured, in the second state, to change the first voice signal having a first frequency to the first voice data having a second frequency by applying the at least one filter. When the instructions are executed, the at least one processor may be configured, in the third state, to change the first voice signal having the first frequency to second voice data 302-1 having the first frequency.

For example, when the instructions are executed, the at least one processor may be configured, in the second state, based on identifying the first voice signal including noise, to change the first voice signal having the first frequency to the first voice data having the second frequency by applying the at least one filter for removing the noise.

When the instructions are executed, the at least one processor may be configured to at least temporarily cease tuning the first voice signal in the third state in response to an input for at least temporarily ceasing the transmission of the first voice data to the external electronic device.

For example, when the instructions are executed, the at least one processor may be configured, in the first state for transmitting a request signal for establishing the call connection with the external electronic device, to at least temporarily cease processing the first voice signal.

For example, when the instructions are executed, the at least one processor may be configured, in the third state, based on identifying the first state related to the call connection indicating an automated response service (ARS), to at least temporarily cease processing the first voice signal.

When the instructions are executed, the at least one processor may be configured, in the second state, to change the first voice signal to the first voice data in which a voice portion is enhanced, by applying the at least one filter to the first voice signal.

For another example, when the instructions are executed, the at least one processor may be configured to change the first voice signal to the first voice data by applying the at least one filter to the first voice signal received in the second state, while an input for transmitting the first voice data to the external electronic device is maintained. When the instructions are executed, the at least one processor may be configured to at least temporarily cease tuning the first voice signal in the third state while the input is not maintained.

As described above, in a method of an electronic device 101 according to an embodiment, the method may comprise, in a first state related to a call connection with an external electronic device 201, based on at least one of a first voice signal 301 obtained through a microphone 240, a second voice signal 303 received through communication circuitry 260, and the first state, determining whether to tune the first voice signal. The method may comprise, in a second state for tuning the first voice signal, obtaining first voice data for transmission to the external electronic device, by applying at least one filter 223 or 225 to the first voice signal. The method may comprise, in a third state distinct from the second state, at least temporarily ceasing the application of the at least one filter to the first voice signal.

For example, the method may comprise, in the second state, changing the first voice signal having a first frequency to the first voice data having a second frequency by applying the at least one filter. The method may comprise, in the third state, changing the first voice signal having the first frequency to second voice data 302-1 having the first frequency.

For another example, the changing to the first voice data may comprise, in the second state, based on identifying the first voice signal including noise, changing the first voice signal having the first frequency to the first voice data having the second frequency by applying the at least one filter for removing the noise.

The at least temporarily ceasing the application of the at least one filter may comprise at least temporarily ceasing tuning the first voice signal in the third state in response to an input for at least temporarily ceasing the transmission of the first voice data to the external electronic device.

For example, the at least temporarily ceasing the application of the at least one filter may comprise, in the first state for transmitting a request signal for establishing the call connection with the external electronic device, at least temporarily ceasing processing the first voice signal.

The at least temporarily ceasing the application of the at least one filter may comprise, in the third state, based on identifying the first state related to the call connection indicating an automated response service (ARS), at least temporarily ceasing processing of the first voice signal.

For example, the changing to the first voice data may comprise, in the second state, changing the first voice signal to the first voice data in which a voice portion is enhanced, by applying the at least one filter to the first voice signal.

In a computer readable storage medium storing one or more programs according to an embodiment as described above, the one or more programs, when executed by a processor 210 of an electronic device 101, may be configured to cause the electronic device to, in a first state related to a call connection with an external electronic device 201, based on at least one of a first voice signal 301 obtained through a microphone 240, a second voice signal 303 received through communication circuitry 260, and the first state, determine whether to tune the first voice signal. The one or more programs, when executed by the processor of the electronic device, may be configured to cause the electronic device to, in a second state for tuning the first voice signal, obtain first voice data for transmission to the external electronic device, by applying at least one filter 223 or 225 to the first voice signal. The one or more programs, when executed by the processor of the electronic device, may be configured to cause the electronic device to, in a third state distinct from the second state, at least temporarily cease the application of the at least one filter to the first voice signal.

The one or more programs, when executed by the processor of the electronic device, may be configured to cause the electronic device to, in the second state, change the first voice signal having a first frequency to the first voice data having a second frequency by applying the at least one filter. The one or more programs, when executed by the processor of the electronic device, may be configured to cause the electronic device to, in the third state, change the first voice signal having the first frequency to second voice data 302-1 having the first frequency.

For example, the one or more programs, when executed by the processor of the electronic device, may be configured to cause the electronic device to, in the second state, based on identifying the first voice signal including noise, change the first voice signal having the first frequency to the first voice data having the second frequency by applying the at least one filter for removing the noise.

The one or more programs, when executed by the processor of the electronic device, may be configured to cause the electronic device to at least temporarily cease tuning the first voice signal in the third state in response to an input for at least temporarily ceasing the transmission of the first voice data to the external electronic device.

For example, the one or more programs, when executed by the processor of the electronic device, may be configured to cause the electronic device to, in the first state for transmitting a request signal for establishing the call connection with the external electronic device, at least temporarily cease processing the first voice signal.

The device described above may be implemented as a hardware component, a software component, and/or a combination of a hardware component and a software component. The devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be, for example, distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and a digital versatile disc (DVD), magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure the has been shown and described with reference to various embodiments thereof, it will be understood by those skilled in the art that various changes in form and details may be made therein without departing from the spirit and the scope of the disclosure as defined by the appended claims and their equivalents.

No claim element is to be construed under the provisions of 35 U.S.C. § 112, sixth paragraph, unless the element is expressly recited using the phrase “means for“ or ”means.”

What is claimed is:

1. An electronic device, comprising:
communication circuitry;
a microphone;
memory, comprising one or more storage media, storing instructions; and
at least one processor communicatively coupled to the communication circuitry, the microphone, and the memory,
wherein the instructions, when executed by the at least one processor individually or collectively, cause the electronic device to:
in a first state related to a call connection with an external electronic device, based on at least one of a first voice signal obtained through the microphone, a second voice signal received through the communication circuitry, and the first state, determine whether to tune the first voice signal,
in a second state for tuning the first voice signal, obtain first voice data for transmission to the external electronic device, by applying at least one filter to the first voice signal, and
in a third state distinct from the second state, at least temporarily cease an application of the at least one filter to the first voice signal.

2. The electronic device of claim 1, wherein the instructions, when executed by the at least one processor individually or collectively, further cause the electronic device to:
in the second state, change the first voice signal having a first frequency to the first voice data having a second frequency by applying the at least one filter; and
in the third state, change the first voice signal having the first frequency to second voice data having the first frequency.

3. The electronic device of claim 2, wherein the instructions, when executed by the at least one processor individually or collectively, further cause the electronic device to:
in the second state, based on identifying the first voice signal including noise, change the first voice signal having the first frequency to the first voice data having the second frequency by applying the at least one filter for removing the noise.

4. The electronic device of claim 1, wherein the instructions, when executed by the at least one processor individually or collectively, further cause the electronic device to:
in response to an input for at least temporarily ceasing the transmission of the first voice data to the external electronic device, at least temporarily cease tuning the first voice signal in the third state.

5. The electronic device of claim 1, wherein the instructions, when executed by the at least one processor individually or collectively, further cause the electronic device to:
in the first state for transmitting a request signal for establishing the call connection with the external electronic device, at least temporarily cease processing the first voice signal.

6. The electronic device of claim 5, wherein the instructions, when executed by the at least one processor individually or collectively, further cause the electronic device to:
in the third state, based on identifying the first state related to the call connection indicating an automated response service (ARS), at least temporarily cease processing the first voice signal.

7. The electronic device of claim 1, wherein the instructions, when executed by the at least one processor individually or collectively, further cause the electronic device to:
in the second state, change the first voice signal to the first voice data in which a voice portion is enhanced, by applying the at least one filter to the first voice signal.

8. The electronic device of claim 1, wherein the instructions, when executed by the at least one processor individually or collectively, further cause the electronic device to:
while an input for transmitting the first voice data to the external electronic device is maintained, change the first voice signal to the first voice data by applying the at least one filter to the first voice signal received in the second state; and
while the input is not maintained, at least temporarily cease tuning the first voice signal in the third state.

9. A method of operating an electronic device, the method comprising:
in a first state related to a call connection with an external electronic device, based on at least one of a first voice signal obtained through a microphone, a second voice signal received through communication circuitry, and the first state, determining whether to tune the first voice signal;
in a second state for tuning the first voice signal, obtaining first voice data for transmission to the external electronic device, by applying at least one filter to the first voice signal; and
in a third state distinct from the second state, at least temporarily ceasing an application of the at least one filter to the first voice signal.

10. The method of claim 9, further comprising:
in the second state, changing the first voice signal having a first frequency to the first voice data having a second frequency by applying the at least one filter; and
in the third state, changing the first voice signal having the first frequency to second voice data having the first frequency.

11. The method of claim 10, wherein the changing of the first voice signal having the first frequency to the first voice data comprises:
in the second state, based on identifying the first voice signal including noise, changing the first voice signal having the first frequency to the first voice data having the second frequency by applying the at least one filter for removing the noise.

12. The method of claim 9, wherein the at least temporarily ceasing of the application of the at least one filter comprises:
in response to an input for at least temporarily ceasing the transmission of the first voice data to the external electronic device, at least temporarily ceasing tuning the first voice signal in the third state.

13. The method of claim 9, wherein the at least temporarily ceasing of the application of the at least one filter comprises:
in the first state for transmitting a request signal for establishing the call connection with the external electronic device, at least temporarily ceasing processing of the first voice signal.

14. The method of claim 13, wherein the at least temporarily ceasing of the application of the at least one filter comprises:
in the third state, based on identifying the first state related to the call connection indicating an automated response service (ARS), at least temporarily ceasing processing of the first voice signal.

15. The method of claim 10, wherein the changing of the first voice signal having the first frequency to the first voice data comprises:
in the second state, changing the first voice signal to the first voice data in which a voice portion is enhanced, by applying the at least one filter to the first voice signal.

16. One or more non-transitory computer readable storage media storing one or more computer programs including computer-executable instructions that, when executed by at least one processor of an electronic device individually or collectively cause the electronic device to perform operations, the operations comprising:
in a first state related to a call connection with an external electronic device, based on at least one of a first voice signal obtained through a microphone, a second voice signal received through communication circuitry, and the first state, determining whether to tune the first voice signal;
in a second state for tuning the first voice signal, obtaining first voice data for transmission to the external electronic device, by applying at least one filter to the first voice signal; and
in a third state distinct from the second state, at least temporarily ceasing an application of the at least one filter to the first voice signal.

17. The one or more non-transitory computer readable storage media of claim 16, the operations further comprising:
in the second state, changing the first voice signal having a first frequency to the first voice data having a second frequency by applying the at least one filter; and
in the third state, changing the first voice signal having the first frequency to second voice data having the first frequency.

18. The one or more non-transitory computer readable storage media of claim 17, the operations further comprising:
in the second state, based on identifying the first voice signal including noise, changing the first voice signal having the first frequency to the first voice data having the second frequency by applying the at least one filter for removing the noise.

19. The one or more non-transitory computer readable storage media of claim 16, the operations further comprising:
in response to an input for at least temporarily ceasing the transmission of the first voice data to the external electronic device, at least temporarily ceasing tuning the first voice signal in the third state.

20. The one or more non-transitory computer readable storage media of claim 16, the operations further comprising:
in the first state for transmitting a request signal for establishing the call connection with the external electronic device, at least temporarily ceasing processing the first voice signal.
